(19) United States
(12) Patent Application Publication
(10) Pub. No.: US 2015/0238028 A1
(43) Pub. Date: Aug. 27, 2015

(54) SUSPENSION STRAP

(71) Applicant: MISSRY ASSOCIATES, INC., DUNELLEM, NJ (US)

(72) Inventor: Morris MOSKOWITZ, Monsey, NY (US)

(21) Appl. No.: 14/629,156

(22) Filed: Feb. 23, 2015

Related U.S. Application Data
(60) Provisional application No. 61/966,343, filed on Feb. 21, 2014.

(51) Int. Cl. A47G 7/04; F16M 11/40

(52) U.S. Cl. CPC A47G 7/041; F16M 11/40

(57) ABSTRACT

A plant strap adapted to suspend a potted plant in a larger empty container. The plant strap has three or more hook elements positioned at a first end of elongated straps having a first and a second end, where the second end is connected at a common base. The common base, in combination with the straps is sized to accommodate the base of a potted plant container while the straps are sized so that the hook elements engage a rim of a larger empty container.

This application claims the benefit of Provisional Application Ser. No. 61/966,343, filed Feb. 21, 2014.

### BACKGROUND OF THE INVENTION

Potted plants from growers come in disposable or unsightly flower pots that are not usually acceptable for indoor displays. Typically, potted plants are transplanted into decorative pots which involve the necessity of providing additional potting soil to fill the planter and the disposal of unwanted pots.

In the case of tall planters which generally are those having a height of 12 to 20 or more inches, a large volume of soil is required. A shelf in the planter that supports plant in a tall planter requires additional mold tooling and the so of additional plastic to mold the planter. Including a molded shelf with a planter causes shipping problems and possible separation of the shelf from the planter is a common problem. In addition, the inclusion of a shelf requires a larger shipping container.

### SUMMARY OF THE INVENTION

The present invention provides a suspension strap that is adapted to suspend a potted plant in a larger empty container so that plants of different sizes may be placed in said larger and usually more decorative containers without the need to transplant the potted plant into the container. The suspension strap comprises three or more hook elements positioned at a first end of elongated straps having a first and a second end, said second end of the elongated straps being connected at a common base, said base in combination with said straps being sized to accommodate the base of a potted plant container while the straps are sized so that said hook elements engage a rim of said larger empty container.

The larger container may also function as a collector of excess water that is spilled when watering the potted plant or drains from the potted plant through a typical drainage hole.

### BRIEF DESCRIPTION OF THE SEVERAL VIEWS OF THE DRAWINGS

FIG. 1 is a perspective view of a strap for suspending a potted plant in an empty container where the base element has an opening in the bottom.

FIG. 2 is a cross-sectional view of the strap of FIG. 1 taken through the center of two opposite straps and the center of the base.

FIG. 3 is a bottom view of the strap of FIG. 1.

FIG. 4 is a perspective view of a plant strap where there is no hole in the base.

FIG. 5 is a strap according to the invention which in a folded position for saving space during shipping.

FIG. 6 is a phantom view of a shipping container with the folded plant strap positioned for shipping.

FIG. 7 is a phantom view of a larger container for holding a potted plant which is positioned in a shipping container above a folded strap according to the invention.

### DETAILED DESCRIPTION OF THE INVENTION

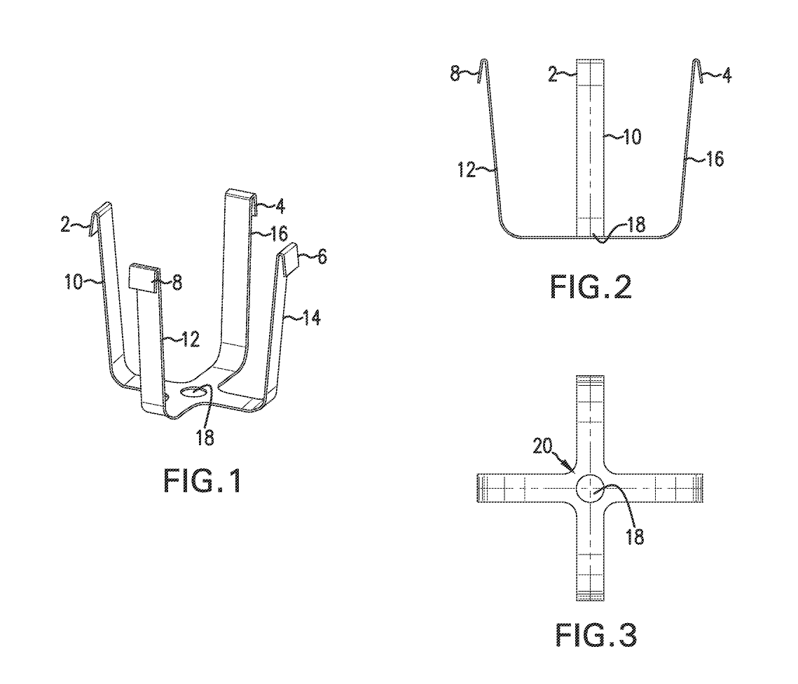

The strap of the invention may be made of any suitable material although plastic and metals such as steel and aluminum are preferred. The straps may be made by stamping out a pattern of the strap and folding or bending the flat stamped out blank so that it forms the general shape of FIG. 1.

The embodiment of FIG. 1 has four hooks and arms but three hooks and arms may be utilized for circular containers. The ends 2, 4, 6 and 8 of the strap are formed into hooks that are adapted to engage the rim of a container that is larger that the potted plant that is to be suspended. The length of the arms 10, 12, 14 and 16 of the strap is determined by the size of the potted plant that is to be suspended. Generally, the arms 11, 12, 14 and 16 will be sized so that when the suspended potted plant is suspended in a container with hooks 2, 4, 6 and 8 will be suspended so that only the plant will be visible when viewed from the side of the larger container. Generally the height of the container will be more than twice the height of the potted plant. The arms 11, 12, 13 and 14 are connected together to form a base element 20 at their ends that are opposite to hooks 2, 4, 6 and 8. The base element may be made by direct molding of a plastic composition where the arms and base are seamlessly formed in one structure as shown by the broken lines in FIG. 3. In such an embodiment the base element may be described as a zone that that is continuous with the arms and is not a discrete element. In an alternative embodiment, the base 20 may be a separate structure that is connected to the arms by sonic welding, adhesives or mechanical connective elements such as bolts or press-fit connection elements at the ends of the arms that can mate with connection elements on a base member.

FIG. 2 shows the profile of arms 12 and 16 which are shaped to accommodate a potted plant. Flexible material may be used for forming the arms so that the arms will deform to accommodate a plurality of differently shaped potted plants. Hole 18 is shown in FIG. 3 which may be provided to avoid blocking the drainage hole in the plant pot.

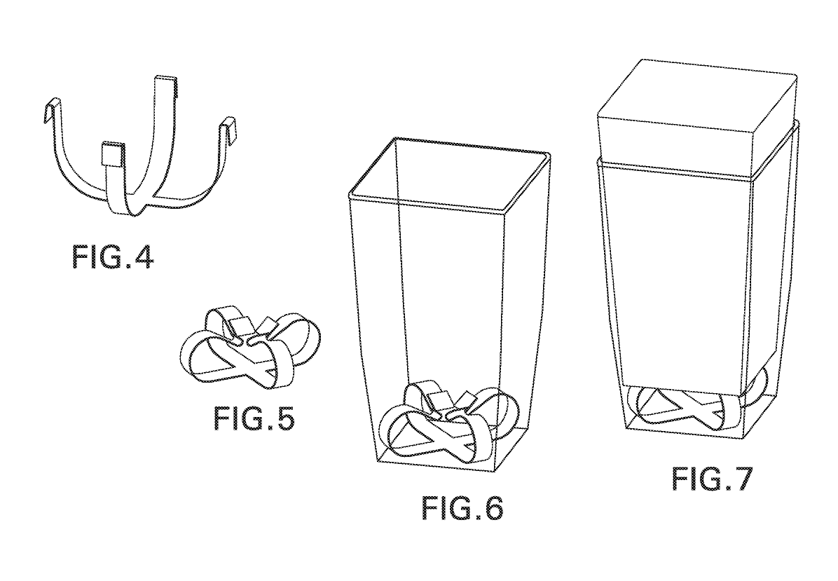

FIG. 4 shows an embodiment of the plant strap that is not provided with a hole in the base element. FIG. 5 shows the plant strap of FIG. 4 in a folded configuration for shipping which can be positioned in a container shown in FIG. 6 which is suitable for use with the plant strap and a potted plant. The positioning of the strap in the container prevents the separation of the strap from the container during shipping.

FIG. 7 shows an alternate embodiment of a larger container for holding a potted plant which is positioned in a shipping container above a folded strap according to the invention.

1. A plant strap adapted to suspend a potted plant in a larger empty container, said plant strap comprising three or more hook elements positioned at a first end of elongated straps having a first and a second end, said second end being connected at a common base, said base in combination with said straps being sized to accommodate the base of a potted plant container while the straps are sized so that said hook elements engage a rim of said larger empty container.

2. A plant strap as define in claim 1, where said plant strap comprises three hook elements.

3. A plant strap as defined in claim 1, where said common base is a zone in said elongated straps that is positioned to accommodate the base of a potted plant container.

4. A plant strap as defined in claim 1, where the strap is made of plastic.

5. A plant strap as defined in claim 1, where the strap is made of aluminum.

6. A plant strap as defined in claim 1, where the strap is made of steel.
